(19) United States
(12) Patent Application Publication
(10) Pub. No.: US 2025/0273967 A1
(43) Pub. Date: Aug. 28, 2025

(54) COMPUTER IMPLEMENTED METHOD AND SYSTEM FOR DISPATCHING MACHINES BASED ON ALLOCATED POWER

(71) Applicant: Caterpillar Inc., Peoria, IL (US)

(72) Inventors: Russell Allen Brockhurst, Carindale (AU); Stefan Jacob Wulf, Washington, IL (US)

(73) Assignee: Caterpillar Inc., Peoria, IL (US)

(21) Appl. No.: 18/588,918

(22) Filed: Feb. 27, 2024

(51) Int. Cl. H02J 3/46; H02J 3/00; H02J 3/18

(52) U.S. Cl. CPC H02J 3/46; H02J 3/003; H02J 3/18

(57) ABSTRACT

An energy management system (EMS) manages allocations of power to charging stations and other power resources at a worksite. The EMS provides a planning system with long-term power data indicating maximum and/or expected power allocations over a relatively long period of time, and provides a dispatch system with short-term power data indicating current and/or expected power allocations over a shorter period of time. The planning system determines a work plan for jobs at the worksite based on power allocations indicated by the long-term power data. The dispatch system assigns machines at the worksite to perform tasks associated with the jobs identified by the work plan, based on power allocations indicated by the short-term power data.

### TECHNICAL FIELD

The present disclosure relates to dispatching machines at a worksite and, more particularly, to dispatching machines based at least in part on data indicating how power resources are allocated at the worksite.

### BACKGROUND

Machines, such as haul trucks and other work machines, may perform various activities at a mine site, a construction site, or another type of worksite e.g., a quarry. As an example, a haul truck may be loaded with material at a first location at a worksite and transport the material to a second location at the worksite. As another example, a haul truck may travel to a weigh station at a worksite to be weighed at the weigh station.

Such machines may be battery electric machines (BEMs) or other types of machines e.g., diesel electric hybrid machines that operate at a worksite, at least in part, on power provided by energy infrastructure at the worksite. The energy infrastructure may include charging stations, power lines, substations, and/or other types of nodes. For example, a BEM may connect to a charging station to receive energy that may be used to charge a battery of the BEM and/or to power operations of the BEM.

Various systems have been developed in the past to manage power resources at a worksite. For example, Chinese Publication CN111489047A to Xie et al. (hereinafter “Xie”) describes a system for designing and modeling an off-grid energy supply system for a mine. However, while the system described by Xie may be used to design an energy supply system for a worksite, the system described by Xie may have limited capabilities for determining jobs that are to be performed at the worksite and/or for dispatching machines to perform corresponding operations.

Examples of the present disclosure are directed to overcoming the aforementioned deficiencies.

### SUMMARY

According to a first aspect of the present disclosure, a method includes managing, by an energy management system (EMS) executed via a computing system, allocations of power to power resources associated with a worksite. The method includes generating, by the EMS, long-term power data indicating the allocations of power over a first period of time. The method includes generating, by the EMS, short-term power data indicating the allocations of power over a second period of time, the second period of time being shorter than the first period of time. The method includes providing, by the EMS, the long-term power data to a planning system via a network. The method includes receiving, by a dispatch controller executed via the computing system, a work plan associated with the worksite from the planning system via the network. The work plan indicates at least one job to be performed at the worksite during the first period of time. The planning system can have generated the work plan based, at least in part, on the long-term power data. The method includes dispatching, by the dispatch controller, at least one machine at the worksite to perform operations associated with the at least one job indicated by the work plan based, at least in part, on the allocations of power to the power resources over the second period of time indicated by the short-term power data.

According to a second aspect of the present disclosure, a worksite system, associated with a worksite, includes an energy management system (EMS) and a dispatch controller. The EMS is configured to manage allocations of power to power resources at the worksite. The EMS is also configured to provide a planning system with long-term power data indicating allocations of power to the power resources over a first period of time, and to output short-term power data indicating the allocations of power to the power resources over a second period of time that is shorter than the first period of time. The dispatch controller is configured to receive the short-term power data from the EMS, and to receive a work plan, indicating at least one job to be performed at the worksite during the first period of time, from the planning system. The planning system can have generated the work plan based at least in part on the long-term power data. The dispatch controller is also configured to dispatch at least one machine at the worksite to perform operations, associated with the at least one job indicated by the work plan, based at least in part on the allocations of power to the power resources over the second period of time indicated by the short-term power data.

According to a third aspect of the present disclosure, a computing system includes a processor and a memory having stored thereon computer-executable instructions. The computer-executable instructions, when executed by the processor, cause the processor to manage allocations of power to power resources associated with a worksite. The computer-executable instructions also cause the processor to generate a work plan, indicating at least one job to be performed at the worksite during a first period of time, based on long-term power data indicating the allocations of power to the power resources over the first period of time. The computer-executable instructions additionally cause the processor to dispatch at least one machine at the worksite to perform operations, associated with the at least one job indicated by the work plan, based on least in part on short-term power data indicating the allocations of power to the power resources over a second period of time that is shorter than the first period of time.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 is an exemplary diagrammatic illustration of a worksite system that is configured to dispatch machines at a worksite based in part on power allocation data associated with the worksite.

FIG. 2 is an exemplary diagrammatic illustration of example power allocation data associated with nodes of energy infrastructure associated with the worksite.

FIG. 3 is a flowchart illustrating an exemplary process for providing long-term power data to a planning system and for providing short-term power data to a dispatch controller.

FIG. 4 is a flowchart illustrating an exemplary process for generating a work plan and providing the work plan to a dispatch controller.

FIG. 5 is a flowchart illustrating an exemplary process for dispatching machines to perform operations at the worksite, based on a work plan generated by a planning system and based on short-term power data generated by an energy management system.

FIG. 6 is a schematic illustration depicting an exemplary architecture of a computing system that executes one or more elements described in the present disclosure.

### DETAILED DESCRIPTION

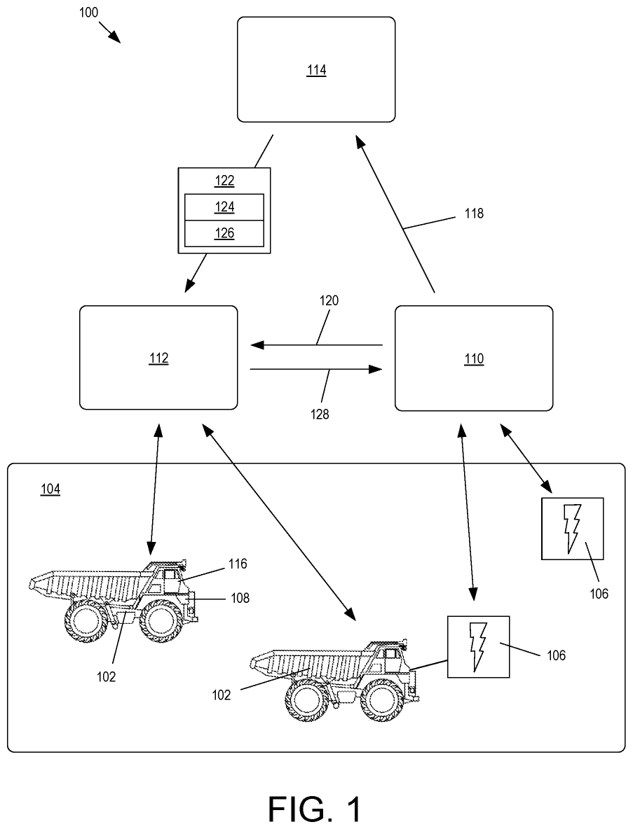

FIG. 1 is an exemplary diagrammatic illustration of a worksite system 100 that is configured to dispatch machines 102 at a worksite 104 based in part on power allocation data associated with the worksite 104. The machines 102 may be battery electric machines (BEMs) or other types of machines that may connect to power resources 106 at the worksite 104, for instance to charge batteries 108 of the machines 102 and/or to power operations of the machines 102. The power resources may include charging stations and/or other energy infrastructure components at, or associated with, the worksite 104. As described herein, the machines 102 may be dispatched to perform operations at the worksite 104 based at least in part on power allocation data indicating how much power the machines 102 are expected to use while performing those operations, and/or how much power is expected to be available to the machines 102 via the power resources 106 during one or more timeframes.

The worksite system 100 may include an energy management system (EMS) 110, a dispatch controller 112, and/or a planning system 114. The EMS 110, the dispatch controller 112, and/or the planning system 114 may send and receive data to communicate with one another as described herein, such that the dispatch controller 112 may dispatch machines 102 to perform operations at the worksite 104 based on information indicating how much power the machines 102 are expected to use and/or how much power is expected to be available via power resources 106 at the worksite 104 at corresponding times and/or locations.

The worksite system 100 may be a computer-implemented system that executes via one or more servers, computers, or other computing devices. Computing elements that execute one or more elements of the worksite system 100, such as the EMS 110, the dispatch controller 112, and/or the planning system 114, may be present on-site at the worksite 104 and/or may be located at one or more back offices or other locations that are remote from the worksite 104.

In some examples, the EMS 110, the dispatch controller 112, and the planning system 114 may be integrated into a single system that operates via the same computing elements. However, in other examples, different elements of the worksite system 100 may be separate and/or may be executed by different computing elements. As an example, the EMS 110 and/or the dispatch controller 112 may execute via a first computing system, while the planning system 114 may execute via a second computing system that may receive data from, and/or send data to, the first computing system. As another example, the EMS 110 and the dispatch controller 112 may be executed via one or more computing systems associated with a first entity that provides and/or manages the machines 102 and/or energy infrastructure elements at the worksite, while the planning system 114 may executed via separate computing systems associated with a second entity, such as a customer of the first entity, that owns the worksite 104 and/or generates goals for the worksite 104.

The worksite 104 may be a mine site, a quarry, a construction site, or any other type of worksite or work environment. One or more machines 102 may operate at the worksite 104 and may perform one or more types of work operations or tasks at the worksite 104, for instance based on instructions provided by the dispatch controller 112.

A machine 102 may, for example, be a commercial or work machine, such as a mining machine, earth-moving machine, backhoe, scraper, dozer, loader (e.g., large wheel loader, track-type loader, etc.), shovel, truck (e.g., mining truck, haul truck, on-highway truck, off-highway truck, articulated truck, etc.), a crane, a pipe layer, a water truck or other machine that dispenses fluid or other material, farming equipment, or any other type of machine or vehicle. In some examples, multiple machines 102 of the same type, and/or different types, may operate at the worksite 104.

As described herein, the dispatch controller 112 may dispatch machines 102 to perform assigned operations at the worksite 104. As an example, the dispatch controller 112 may assign a machine 102 to transport one or more loads of material between locations at the worksite 104. As other examples, the dispatch controller 112 may assign machines 102 to excavate material at locations at the worksite 104, load material onto other machines 102, remove material from other machines 102, dispense water or other liquid at locations at the worksite 104, travel along designated routes at the worksite 104, travel to lime silos, weigh stations, and/or other destinations at the worksite 104, connect to particular power resources 106 at the worksite 104, and/or perform any other activities, operations, or tasks at the worksite 104.

The machines 102 may include staffed manually operated machines, fully autonomous machines, and/or semi-autonomous machines. A machine 102 may have an electronic control module (ECM) 116 and/or other on-board computing devices that may cause the machine 102 to perform autonomous or semi-autonomous operations, for instance based on instructions provided by the dispatch controller 112. Some machines 102, such as manually operated machines or semi-autonomous machines, may have on-board displays or other components that may present instructions from the dispatch controller 112 to drivers or other operators of the machines 102, such that the operators may cause the machines 102 to perform operations assigned by the dispatch controller 112. The machines 102 may also have sensors, wireless communication components, and/or other elements that allow the ECMs 116 and/or other on-board computing devices to receive instructions from the dispatch controller 112, cause the machines 102 to perform assigned tasks based on the instructions received from the dispatch controller 112, provide sensor data and/or progress reports to the dispatch controller 112, and/or perform other operations.

In some examples, a machine 102 may be at least partially powered by a battery 108. For example, a machine 102 may be a BEM, a hybrid machine that is powered by both a battery and fuel, a fuel cell and battery hybrid machine, or another machine that is at least partially powered by a battery 108. The battery 108 may be a lithium-ion (Li-ion) battery, lithium-iron-phosphate battery, solid-state lithium battery, lithium-ion polymer battery, nickel-metal hydride (NiMH) battery, lead-acid battery, nickel cadmium (Ni—Cd) battery, zinc-air battery, sodium-nickel chloride battery, or other type of battery that may at least partially power the machine 102.

In other examples, a machine 102 may be another type of machine that includes elements powered by energy provided by a battery 108 and/or connections to power resources 106. For example, a machine 102 may use one or more electric drives for propulsion, and may power the electric drives via one or more sources such as diesel fuel, a battery 108 of the machine 102, and/or a connection to a charging station, external energy source, or other power resource 106.

Accordingly, machines 102 may operate at the worksite 104 using power provided via power resources 106 at the worksite 104. The power resources 106 may be nodes and/or other elements of energy infrastructure located at, and/or associated with, the worksite 104. The power resources 106 may include charging stations, battery swap stations, and/or other elements that may provide energy to machines 102. The power resources 106 may also include other elements that generate or provide power, and/or that transfer or distribute energy among charging stations or other power resources 106 at the worksite 104. For example, the power resources may include power transfer lines and/or electrical substations that transfer energy to charging stations or other elements at the worksite 104, generators and/or external power sources that generate power and/or provide energy to other elements at the worksite 104, and/or other energy infrastructure components. Machines 102 may connect to charging stations and/or other power resources 106 to charge batteries 108 and/or to receive energy that may be used to power operations of the machines 102.

Charging stations may include stationary charging stations that machines 102 may connect to, and wait at, in order to charge batteries 108 of the machines 102 based on energy transferred from the stationary charging stations. Some machines 102 may also connect to such charging stations or other power resources 106 to receive energy that may directly power operations of the machines 102 while the machines 102 are stationary and are connected to the power resources 106. For instance, a machine 102 may be a tethered machine that is powered based on an ongoing connection to one or more power resources 106.

Charging stations may also, or alternately, include trolley systems or other dynamic charging stations that machines 102 may connect to in order to receive energy while the machines 102 are in motion and maintain connections to the charging stations. For example, a trolley system may transfer energy to a machine 102 while the machine 102 travels along a length of the trolley system. Accordingly, the machine 102 may receive energy to charge a battery 108 of the machine 102 and/or power operations of the machine 102 while the machine 102 is traveling and is connected to the trolley system.

For instance, a trolley system may include electrified charging rails, wires, and/or other electrified components or charging mechanisms that extend through a portion of the worksite 104. Charging rails or wires of the trolley system may be positioned on, above, or alongside a portion of a road or other travel route at the worksite 104. A machine 102 may have a connector, such as rod, that may at least temporarily connect with a trolley system, and that may remain connected to elements of the trolley system as the machine 102 travels above, under, or alongside a length of the trolley system. The connector may be configured to transfer energy from the trolley system to a battery 108 and/or other electrical components of the machine 102.

The design of a trolley system may also, or alternately, employ trolley poles, bow collectors, underbody collectors, and other forms of ‘live’ electricity transfer components. As an example, a trolley system may include a ground-level power supply that has one or more contact lines that may include conductive rails or tracks, and a machine 102 may have an underbody collector that interacts with the contact lines of the ground-level power supply. As another example, a trolley system may include non-contact conductors, such as non-contact conductors that facilitate in-road or in-ground inductive charging. Accordingly, a trolley system may embody any form of ‘live’ electricity supply and machines 102 may have corresponding components that embody any form of ‘live’ electricity receipt, depending on specific applicational requirements, such that machines 102 may receive energy from a trolley system while traveling along the trolley system.

In some examples, a trolley system may provide a machine 102 with power while the machine 102 is in motion and is connected to the trolley system. In other examples, a trolley system may be configured to provide power to a connected machine 102 while the machine 102 is either in motion or is stationary.

The power resources 106 may include other types of energy infrastructure nodes or elements in addition to, and/or instead of, charging stations. As an example, the power resources 106 may include battery swap stations that are configured to remove batteries 108 of machines 102 and to replace the removed batteries 108 with other batteries 108 that have higher charge levels. As another example, the power resources 106 may include power lines, electrical substations, and/or other infrastructure elements that transfer and/or distribute electricity to charging stations and other energy infrastructure nodes at the worksite 104.

The power resources 106 may also include power sources, such as generators, external power sources, and/or other elements, that may provide power that may be distributed to other power resources 106 at the worksite 104. For example, the power resources 106 may include solar panels, wind turbines, hydroelectric generators, and/or renewable energy sources or power generators. As another example, the power resources 106 may include fuel-powered generators, connections to external electrical grids, and/or other power sources. Power provided by such power sources may be allocated and/or distributed to charging stations and/or other energy infrastructure components at the worksite 104. For instance, a portion of an overall amount of power provided by a set of solar panels may be allocated to a particular charging station at the worksite 104, such that one or more machines 102 that connect to the particular charging station may access the power allocated to the particular charging station.

The EMS 110 may monitor and/or control power resources 106 at the worksite 104. As noted above, the EMS 110 may be a computer-implemented system that executes via one or more servers, computers, or other computing devices. The EMS 110 may also include, or be linked to, physical equipment associated with individual power resources 106 or sets of power resources 106, such as sensors or other monitoring components, controllers, power units, switches, gears, and/or other types of equipment that may monitor and/or control the power resources 106. The EMS 110 may execute based on software and/or other computer-executable instructions that executes on one or more local computing devices at the worksite 104, on one or more remote servers, via one or more elements of a cloud computing environment, and/or as embedded software that executes on microgrid controllers, power units, switches, and/or other types of equipment associated with a power management and/or distribution system.

The EMS 110 may monitor and/or control power resources 106 at the worksite 104 by tracking, determining, and/or changing allocations of power to different charging stations or other power resources 106. For instance, the EMS 110 may monitor and/or control allocations of power to individual power resources 106 by turning generators on or off, by tracking how much power is being provided by power sources to other power resources 106, by predicting or estimating how much power will be available at one or more power resources 106 at future times, and/or by otherwise managing or controlling the power resources 106. As discussed above, machines 102 may connect to charging stations and/or other power resources 106 managed by the EMS 110, for instance to power operations of the machines 102 and/or to charge batteries 108 of the machines 102.

The EMS 110 may provide the planning system 114 with long-term power data 118 associated with the power resources 106 managed by the EMS 110. The EMS 110 may also, or alternately, provide the dispatch controller 112 with short-term power data 120 associated with the power resources 106 managed by the EMS 110.

The long-term power data 118 and/or the short-term power data 120 may be expressed via Extensible Markup Language (XML) data, attribute-value pairs, and/or other types of data or data formats. The long-term power data 118 and/or the short-term power data 120 may indicate power levels associated with corresponding power resources 106 over periods of time. As an example, the long-term power data 118 and/or the short-term power data 120 may indicate power levels that are expected to be associated with corresponding power resources 106 during one or more future time intervals. As discussed further below, the long-term power data 118 and/or the short-term power data 120 may also be represented as, and/or be formatted as, a tree or other hierarchical structure that indicates power levels associated with corresponding nodes.

The EMS 110 may provide new or updated short-term power data 120 to the dispatch controller 112 relatively frequently, such as in real-time, near real-time, every fifteen minutes, every half hour, every hour, or on any other relatively frequent basis. In some examples, the EMS 110 may provide new or updated long-term power data 118 to the planning system 114 on a relatively infrequent basis, such as once every four hours, once every twelve hours, once a day, once every other day, once a week, or on any other schedule. However, in other examples, the EMS 110 may provide new or updated long-term power data 118 to the planning system 114 on a more frequent basis, such as at some or all of the times when the EMS 110 provides new or updated short-term power data 120 to the dispatch controller 112.

The long-term power data 118 provided by the EMS 110 to the planning system 114 may indicate power levels that the EMS 110 predicts or estimates will be available at corresponding power resources 106 over a relatively long period of time, such as at one or more times over the next day or the next week. In some examples, the long-term power data 118 may indicate maximum and/or expected power levels associated with some or all of the power resources 106 associated with the worksite 104, and/or that are associated with individual power resources 106 such as individual sub-stations, individual charging stations, different dispensers at the same charging stations, and/or other individual nodes of energy infrastructure associated with the worksite 104.

In some examples, the power levels indicated by the long-term power data 118 may be maximum power levels that are based on physical limits of the power resources 106. As a non-limiting example, physical components of a particular charging station may limit the charging station from being allocated more than 8 MW at any time, and the long-term power data 118 may accordingly indicate a maximum power level of 8 MW associated with the charging station.

In other examples, the power levels indicated by the long-term power data 118 may also, or instead, be based on expected or predicted allocations of power at particular times, and/or based on expected usage of power at particular times. Such expectations or predictions may be generated by the EMS 110 based on weather data, times of day, maintenance plans, energy availability schedules, dispatch data received from the dispatch controller 112, and/or other factors.

As a non-limiting example, a particular charging station may have a physical limit of 6 MW, but rely on power provided by a set of solar panels. Weather predictions may indicate that cloudy weather conditions expected during a particular day are likely to limit the set of solar panels to providing 3 MW to the particular charging station. Accordingly, the long-term power data 118 may indicate that 3 MW of power is expected to be available via the particular charging station during the particular day, instead of or in addition to indications that the particular charging station has a physical limit of 6 MW.

As another non-limiting example, the EMS 110 may receive data from the dispatch controller 112 that indicates when and where the dispatch controller 112 plans to dispatch machines 102 to access energy via power resources 106, and/or that requests corresponding changes to amounts of power allocated to power resources 106. The EMS 110 may use data received from the dispatch controller 112 to determine how much power is expected to be used at power resources 106 at one or more times, verify whether power allocated to the power resources 106 is likely to satisfy such expected power usage levels at one or more times, and/or to adjust allocations of power to the power resources 106 at one or more times. Accordingly, the long-term power data 118 may indicate expected power usage levels associated with power resources 106 during one or more periods of time, instead of or in addition to amounts of power that are expected to be available at the power resources 106.

As another non-limiting example, a maintenance plan may indicate that a charging station is scheduled to be taken offline for maintenance on a particular day. Accordingly, the long-term power data 118 may indicate that no power is expected to be available or used at that charging station during that particular day, but that other defined power levels are likely to be available and/or used at the charging station on other days.

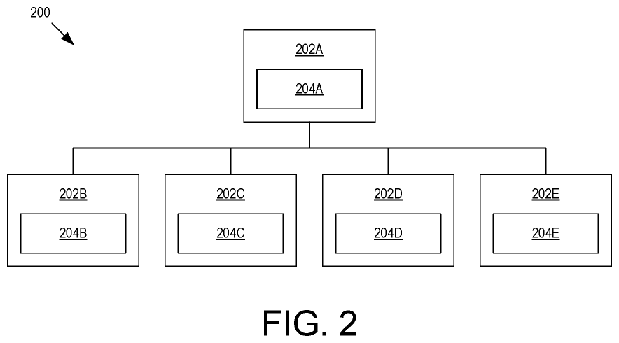

In some examples, the long-term power data 118 may be represented and/or formatted as a tree or other hierarchical structure that indicates power levels associated with corresponding nodes. For instance, the long-term power data 118 may include, or be represented as, a tree with nodes, such as parent nodes, child nodes, grandchild nodes, and/or other types of nodes, that represent elements of energy infrastructure associated with the worksite 104. The tree may also indicate power levels associated with corresponding nodes and/or relationships between power levels of nodes, for example as discussed further below with respect to FIG. 2. As an example, the long-term power data 118 may indicate that a parent node, such as a power source, may provide power to a set of charging stations represented by child nodes linked to the parent node.

In some examples, the long-term power data 118 may indicate that a sum of maximum power levels associated with a set of child nodes exceeds a maximum power level associated with a corresponding parent node. For instance, a parent node may be associated with a maximum power level of 12 MW, while four child nodes of the parent node may each be associated with a maximum power level of 4 MW. In this example, a sum of the maximum power levels of the four child nodes is 16 MW and thus exceeds the 12 MW maximum power level of the parent node. The sum of the maximum power levels of the child nodes exceeding the maximum power level of the parent node may indicate that although each of the child nodes may be allocated up to 4 MW, the maximum of 12 MW that may be allocated to the parent node may be allocated across all of the four child nodes. For example, a total of 12 MW available to the parent node may be divided by allocating 3 MW to each of the four child nodes, by allocating 4 MW each to three of the child nodes and allocating 0 MW to the fourth child node, or by otherwise allocating different levels of power to the child nodes such that the total power allocated across the four child nodes does not exceed 12 MW.

In addition to providing the long-term power data 118 to the planning system 114, the EMS 110 may also provide short-term power data 120 to the dispatch controller 112. The short-term power data 120 may indicate power levels that are currently available at corresponding power resources 106, and/or that the EMS 110 predicts or estimates will be available at the power resources 106 over a relatively short period of time such as during the next half hour or hour.

Similar to the long-term power data 118, the short-term power data 120 may indicate maximum available power levels, expected power availability levels, and/or expected power usage levels associated with some or all of the power resources 106 associated with the worksite 104. The long-term power data 118 may indicate such power levels that are associated with individual power resources 106, such as individual sub-stations, individual charging stations, different dispensers at the same charging stations, and/or other individual nodes of energy infrastructure associated with the worksite 104. The short-term power data 120 may also, or alternately, indicate current or scheduled power levels that are or will be allocated to corresponding power resources 106.

As an example, the short-term power data 120 may indicate that a particular charging station is currently allocated 4 MW of power, but that the charging station is scheduled to go offline for maintenance in the next fifteen minutes and will then be allocated 0 MW of power. As another example, the short-term power data 120 may indicate that an additional generator is scheduled to be activated in a half hour, and that corresponding allocations of power to one or more power resources 106 are expected to correspondingly increase when the generator is activated. As yet another example, if the EMS 110 receives a notification that a generator has failed unexpectedly, the short-term power data 120 may indicate that less power is now available at one or more power resources 106 than had been expected.

In some examples, the short-term power data 120 may be represented and/or formatted as a tree or other hierarchical structure that indicates power levels associated with corresponding nodes representing energy infrastructure elements associated with the worksite 104, similar to a corresponding tree or other hierarchical structure that may be used to represent long-term power data 118. An example tree of power data is discussed further below with respect to FIG. 2.

The planning system 114 may receive long-term power data 118 from the EMS 110 as discussed above. The planning system 114 may be configured to generate a work plan 122 associated with operations of the machines 102 at the worksite 104, and may provide the work plan 122 to the dispatch controller 112. The work plan 122 may indicate a set of jobs 124 to be performed at the worksite 104 over a period of time, such as over a shift or over an entire day. In some examples, the work plan 122 may also indicate estimated power usage levels 126 corresponding to the set of jobs 124 and/or corresponding power resources 106.

The planning system 114 may, in some examples, generate the work plan 122 based at least in part on user input. For example, a user may use a user interface and/or other elements of the planning system 114 to indicate that particular jobs 124 should be performed at the worksite 104 during a particular work shift. The user input may identify jobs 124, indicate when and/or where the jobs 124 are to be performed at the worksite 104, and/or otherwise define the jobs 124. In other examples, the planning system 114 may be configured to automatically generate the work plan 122 based on goals defined by user input or other data. For instance, the planning system 114 may receive input data specifying a goal of a particular amount of material being excavated from an area of the worksite 104 and being transported away from that area, and the planning system 114 may automatically generate individual jobs 124 that the planning system 114 predicts will cause the goal to be achieved.

However, the planning system 114 may also generate the work plan 122 based at least in part on the long-term power data 118 provided by the EMS 110. For example, because the long-term power data 118 may indicate power levels that are expected to be available at corresponding power resources 106 at the worksite 104 at particular times, the planning system 114 may take such power levels into account when determining a set of jobs 124 to be performed during a shift or a day.

As a non-limiting example, the long-term power data 118 may indicate that charging stations at a first area of the worksite 104 are expected to have 12 megawatts (MW) of power available during a particular shift, and that charging stations at a second area of the worksite 104 are expected to only have 4 MW of power available during that same shift. Accordingly, because the long-term power data 118 indicates that more power is likely to be available at the first area than at the second area during the shift, the planning system 114 may reduce or limit the number of jobs to be performed in the second area during the shift, and may correspondingly increase the number of jobs to be performed in the first area during the shift. By increasing the number of jobs to be performed in the first area that is expected to have higher amounts of available power, and decreasing the number of jobs to be performed in the second area that is expected to have lower amounts of available power, the likelihood of the jobs being able to be completed based on available power at the worksite 104 may be increased.

The planning system 114 may also be configured to determine and/or predict estimated power usage levels 126 associated with corresponding jobs 124 and/or power resources 106. For example, based on the types of the jobs 124, locations at which the jobs 124 are to be performed, locations of power resources 106, and/or other data, the planning system 114 may determine or predict how much power may be used by one or more machines 102 to perform those jobs 124 and/or should be allocated to corresponding power resources 106. The planning system 114 may use historical averages of power usage levels of similar previous jobs, machine learning models trained on historical data indicating power usage levels of previous jobs with similar attributes, and/or any other information or modeling to determine or predict the estimated power usage levels 126 associated with jobs 124 and/or power resources 106 indicated by a work plan 122.

The planning system 114 may use the long-term power data 118 received from the EMS 110 to determine whether power corresponding to estimated power usage levels 126 is likely to be available via the power resources 106 and/or could be allocated to the power resources 106. If the long-term power data 118 indicates that power sufficient to perform defined jobs 124 is unlikely to be available via the power resources 106 and/or may not be allocated to the power resources 106, the planning system 114 may alter the types of jobs 124, the number of jobs 124, the locations at which the jobs 124 are to be performed, and/or any other attributes of the set of jobs 124 such that estimated power usage levels 126 correspond with available power levels indicated by the long-term power data 118.

As discussed above, in some examples the planning system 114 may generate the set of jobs 124 based on user input. In some examples, the planning system 114 may display the long-term power data 118 via a user interface such that a user of the planning system 114 may consider the long-term power data 118 while the user provides input defining jobs 124 to be performed during a corresponding shift or other time period. The planning system 114 may also automatically determine or predict estimated power usage levels 126 based on the user-defined jobs, and present the estimated power usage levels 126 via the user interface such that the user may adjust definitions of jobs 124 based on the corresponding estimated power usage levels 126 and/or the long-term power data 118 associated with available power resources 106. In other examples, the planning system 114 may display warnings or alerts to a user if the long-term power data 118 indicates that sufficient power may not be available to satisfy estimated power usage levels 126 determined based on user input received via the planning system 114, such that the user may adjust the jobs 124 in response to such warnings or alerts.

As discussed above, in some examples the long-term power data 118 may indicate that a sum of maximum power levels associated with a set of child nodes exceeds a maximum power level of a corresponding parent node. In these examples, the planning system 114 may permit planning of jobs 124 if corresponding estimated power usage levels 126 associated with individual child nodes do not exceed the maximum power levels of those child nodes, and that the total estimated power usage level 126 associated with all of the child nodes does not exceed the maximum power level of the parent node.

As a non-limiting example, the long-term power data 118 may indicate that a parent node associated with an area of the worksite has a maximum power level of 12 MW, and that child nodes representing four charging stations within the area of the worksite have maximum power levels of 4 MW each. In this example, the planning system 114 may permit planning of jobs that may be associated with allocations of up to 4 MW of power to each individual charging station, if the jobs in the area are not expected to use more than 12 MW in total.

Overall, the planning system 114 may determine a set of jobs 124 to be performed at the worksite 104 during a shift, a day, or other period of time based at least in part on long-term power data 118 from the EMS 110 that indicates expected power levels of power resources 106 at the worksite 104 at one or more times over the period of time. The planning system 114 may also determine estimated power usage levels 126 associated with the jobs 124 and/or power resources 106. The planning system 114 may provide a work plan 122 for the shift, day, or other time period, indicating the set of jobs 124 and/or corresponding estimated power usage levels 126, to the dispatch controller 112.

The dispatch controller 112 may be configured to dispatch machines 102 to perform tasks at the worksite 104. As described herein, the dispatch controller 112 may dispatch machines 102 based on the work plan 122 received from the planning system 114, based on the short-term power data 120 received from the EMS 110, and/or based on other information. The dispatch controller 112 may select machines 102 to perform tasks and/or operations associated with one or more jobs 124 defined by the work plan 122, determine when and where selected machines 102 are to perform tasks or operations in association with the jobs 124, determine when and where selected machines 102 are to connect to power resources 106, and/or otherwise determine how to dispatch machines 102 to implement the work plan 122. The dispatch controller 112 may transmit corresponding instructions to elements of selected machines 102 that may cause ECMs 116 and/or operators of the machines 102 to cause the machines 102 to perform assigned operations.

As an example, a job 124 indicated by the work plan 122 may indicate that a certain amount of material is to be moved from a first location at the worksite 104 to a second location at the worksite 104 during a three-hour period. The dispatch controller 112 may convert that job 124 into a series of tasks or operations that may be performed by one or more machines 102, such as a series of work cycles that may involve machines 102 being loaded with the material at the first location, traveling while loaded with the material to the second location, dumping the material at the second location, traveling while unloaded back to the first location to be loaded with more material, and at least occasionally connecting to designated charging stations or other power resources 106 to receive energy to charge batteries 108 and/or to power the operation of the machines 102 during the work cycles. As another example, a job 124 indicated by the work plan 122 may identify circuits associated with multiple loading zones and/or multiple dumping zones. In this example, the work plan 122 may convert the job 124 into a series of tasks or operations to be performed by one or more machines 102, such as tasks that involve a machine 102 traveling between the same zones and/or combinations of different zones while at least occasionally connecting to designated charging stations or other power resources 106 to receive energy.

Accordingly, while the jobs 124 defined by the work plan 122 may indicate broader goals to be achieved at the worksite 104 during a shift or other time period, the dispatch controller 112 may determine more detailed tasks, at a more granular level, that may be performed by machines 102 in order to achieve the broader goals identified by the jobs 124 indicated by the work plan 122. The dispatch controller 112 may assign and dispatch particular machines 102 to perform the more detailed tasks determined by the dispatch controller 112.

The dispatch controller 112 may determine and/or adjust how it dispatches machines 102 to perform operations associated with jobs 124 based at least in part on short-term power data 120 received from the EMS 110. As an example, the work plan 122 may indicate that a particular job is to be performed at a particular location at the worksite 104 during a particular shift. The dispatch controller 112 may accordingly select a machine 102 to perform the job, and dispatch the selected machine 102 to perform the job, if the short-term power data 120 indicates that current or expected power levels associated with one or more power resources 106 at or near the particular location are sufficient to power operations of the selected machine 102 before, during, and/or after performance of the particular job by the selected machine 102. For example, performance of the job may involve the selected machine 102 at least occasionally connecting to one or more charging stations to charge a battery 108 of the machine 102 and/or to power operations of the machine 102 before, during, and/or after performance of operations associated with the job. In some examples, the dispatch controller 112 may determine whether power levels available at power resources 106 are sufficient for performance of the job by the selected machine 102 based at least in part on estimated power usage levels 126 indicated in the work plan 122 received from the planning system 114.

In some examples, if the dispatch controller 112 determines that current and/or expected power levels associated with power resources 106, indicated by the short-term power data 120, may be insufficient to assign a machine 102 to perform a job indicated by the work plan 122, the dispatch controller 112 may send a power allocation adjustment request 128 to the EMS 110. The power allocation adjustment request 128 may request that power allocated to one or more power resources 106 at one or more particular locations and/or times be changed such that the dispatch controller 112 may be more likely to be able to assign a machine 102 to perform the job based on the changed power allocations.

When the EMS 110 receives the power allocation adjustment request 128, the EMS 110 may adjust configurations of power resources 106 and/or allocations of power to power resources 106 based on the power allocation adjustment request 128. For example, if the power allocation adjustment request 128 is a request for an increase in a power level allocated to a particular charging station, the EMS 110 may increase the power available at that particular charging station by turning on one or more additional generators, or by allocating more power to the particular charging station and correspondingly decreasing power allocated to one or more other charging stations.

The EMS 110 may provide updated short-term power data 120 to the dispatch controller 112 after reconfiguring power resources 106 and/or adjusting allocations of power to power resources 106 based on the power allocation adjustment request 128. The dispatch controller 112 may accordingly dispatch machines 102 at least in part based on changes made by the EMS 110.

As an example, the short-term power data 120 may initially indicate that a power level allocated to a particular charging station near the location of a job would be insufficient to power operations of a machine 102 in association with performance of the job. The dispatch controller 112 may accordingly submit a power allocation adjustment request 128 requesting that the power level allocated to that particular charging station be increased. The EMS 110 may respond to the power allocation adjustment request 128 by increasing the power level allocated to the particular charging station, and may return updated short-term power data 120 to the dispatch controller 112 to indicate that the power level allocated to the particular charging station has been increased to a level that may be sufficient to power operations of the machine 102 in association with performance of the job. The dispatch controller 112 may accordingly assign the machine 102 to perform the job, based on indications in the power allocation adjustment request 128 that the power level allocated to the particular charging station has been increased.

In some examples, the EMS 110 may be unable to fully comply with a power allocation adjustment request 128, but may attempt to at least partially satisfy the power allocation adjustment request 128. As a non-limiting example, a power allocation adjustment request 128 from the dispatch controller 112 may request that power allocated to a particular charging station be increased from 4 MW to 8 MW. However, the EMS 110 may only have enough available unallocated power, or power that can be reallocated from one or more other power resources 106, to increase the power allocated to that particular charging station be increased from 4 MW to 6 MW. In this example, the EMS 110 may return updated short-term power data 120 to the dispatch controller 112 indicating that the charging station is now allocated 6 MW of power. Accordingly, the dispatch controller 112 may determine whether to dispatch a machine 102 based on the increased power level of 6 MW that is less than the 8 MW level the dispatch controller 112 requested, and/or may adjust how the dispatch controller 112 dispatches one or more machines 102 in response to the lower-than expected increase in the power level associated with the charging station.

Overall, as described herein, the EMS 110, the dispatch controller 112, and/or the planning system 114 of the worksite system 100 may coordinate with one another based on information such as long-term power data 118, short-term power data 120, work plans 122, and/or power allocation adjustment requests 128. The exchange of information may allow the planning system 114 to generate work plans 122 based on current and/or expected power levels associated with power resources 106. The exchange of information may also allow the dispatch controller 112 to dispatch machines 102 to perform operations at the worksite 104 to implement the work plan 122 generated by the planning system 114, based at least in part on current and/or expected power levels associated with power resources 106 and changes that the EMS 110 may make to the power resources 106 based on power allocation adjustment requests 128 from the dispatch controller 112. An example of a tree that may represent long-term power data 118 and/or short-term power data 120 generated by the EMS 110 is shown in FIG. 2, and is discussed further below with respect to that figure.

FIG. 2 is an exemplary diagrammatic illustration of example power allocation data 200 associated with nodes 202 of energy infrastructure associated with the worksite 104. In some examples, the long-term power data 118 provided by the EMS 110 to the planning system 114 may be provided and/or formatted as power allocation data 200 similar to the example power allocation data 200 shown in FIG. 2. In some examples, the short-term power data 120 provided by the EMS 110 to the dispatch controller 112 may also, or alternately, be provided and/or formatted as power allocation data 200 similar to the example power allocation data 200 shown in FIG. 2. The power allocation data 200 may be generated by the EMS 110, and the EMS 110 may provide the power allocation data 200 to one or more other elements of the worksite system 100, for instance as long-term power data 118 and/or short-term power data 120.

Nodes 202 indicated by power allocation data 200, such as nodes 202A, 202B, 202C, 202D, and 202E shown in the example of FIG. 2, may represent individual power resources 106 associated with the worksite 104. For example, the nodes 202 may represent substations, power lines, charging stations, battery swap stations, renewal power sources, generators, external power sources, and/or other elements of energy infrastructure associated with the worksite 104. The power allocation data 200 may identify the nodes 202 and/or locations of the nodes 202 at the worksite 104. The power allocation data 200 may also indicate relationships between the nodes 202 via a tree structure, another hierarchical representation, or other data.

As an example, node 202A may be a parent node that is linked to child nodes 202B, 202C, 202D, and 202E. The child nodes 202B, 202C, 202D, and 202E may each be different charging stations, while the parent node 202A may be a substation or other power resource 106 that may distribute power to the different charging stations represented by the child nodes. Although five nodes 202 are shown in the example of FIG. 2, the power allocation data 200 may include information about more nodes 202 or fewer nodes 202, different types of nodes 202 that represent different types of power resources 106, and/or different relationships between nodes 202. For instance, although FIG. 2 shows two levels of nodes 202 with parent node 202A being linked to four child nodes 202, in other examples there may be additional levels of nodes 202. For example, a parent node 202 may be linked to a set of child nodes 202, and some or all of those child nodes 202 may be linked to one or more corresponding grandchild nodes 202.

As shown in FIG. 2, the power allocation data 200 may indicate power levels 204 that correspond to the nodes 202. For example, the power allocation data 200 may indicate that parent node 202A is associated with power level 204A, and that child nodes 202B, 202C, 202D, and 202E are respectively associated with power levels 204B, 204C, 204D, and 204E.

The power levels 204 indicated by the power allocation data 200 may be current and/or expected power levels that may be available via the corresponding nodes 202 at one or more times. For example, the power levels 204 may indicate maximum power levels that may be available based on physical limitations of the power resources 106 corresponding to the nodes 202, power levels that are currently allocated to the nodes 202, and/or future power levels that are likely to be allocated to the nodes 202 at one or more future times based on schedules, estimates, and/or predictions.

As an example, based on maintenance schedules, weather forecasts that may impact power provided by solar panels, wind turbines, hydroelectric generators, and/or other renewable energy sources, and/or other information, the EMS 110 may estimate or predict power levels 204 that will be available and/or allocated to nodes 202 at one or more future times. The EMS 110 may accordingly indicate such future expected allocated power levels 204 associated with nodes 202 in the power allocation data 200, instead of or in addition to information indicating currently-allocated power levels 204 associated with nodes 202 and/or maximum power levels 204 that could potentially be allocated to the nodes 202.

As discussed above, in some situations a sum of maximum power levels associated with a set of child nodes 202 may exceed a maximum power level associated with a corresponding parent node 202. As a non-limiting example, the power levels 204B, 204C, 204D, and 204E of the child nodes 202B, 202C, 202D, and 202E may indicate that the child nodes 202B, 202C, 202D, and 202E may each have a maximum power allocation of 4 MW. The power level 204A of the parent node 202A may indicate that the parent node 202A may have a maximum power allocation of 12 MW. Accordingly, in this example, if the parent node 202A is allocated 12 MW, the power allocation data 200 may indicate that the 12 MW allocated to the parent node 202A may be divided among the four child nodes 202B, 202C, 202D, and 202E in multiple ways as long as the power allocated to any of the child nodes individually does not exceed 4 MW and the total power allocated to all of the child nodes does not exceed 12 MW. As a first example, 3 MW may be allocated to each of the four child nodes 202B, 202C, 202D, and 202E. As a second example, 4 MW may be allocated to the child node 202B, 2 MW may be allocated to child node 202C, 4 MW may be allocated to child node 202D, and 2 MW may be allocated to child node 202D. As a third example, 4 MW may be allocated to each of child nodes 202B, 202C, and 202D, while child node 202E is allocated 0 MW. Other examples of allocations of power to the child nodes may be possible.

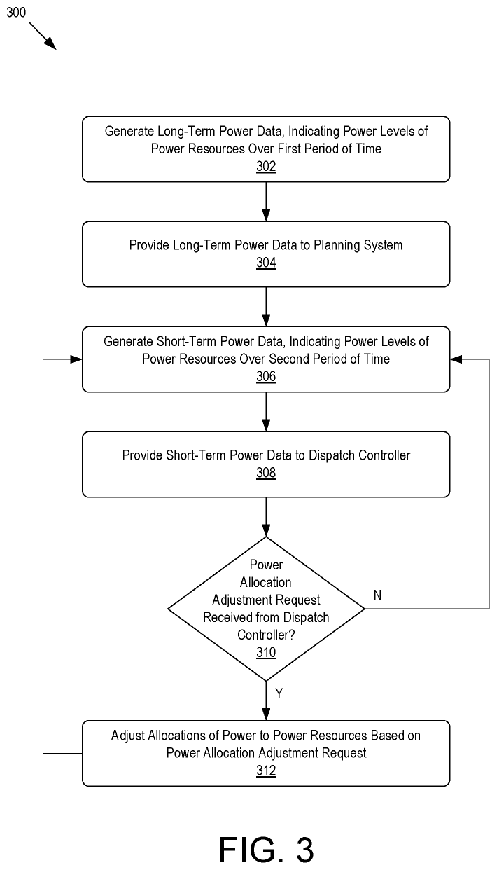

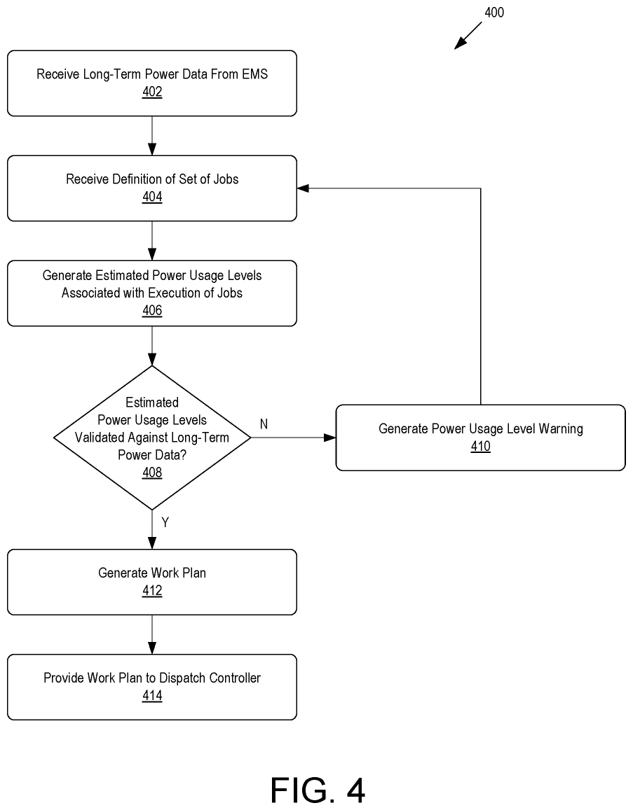

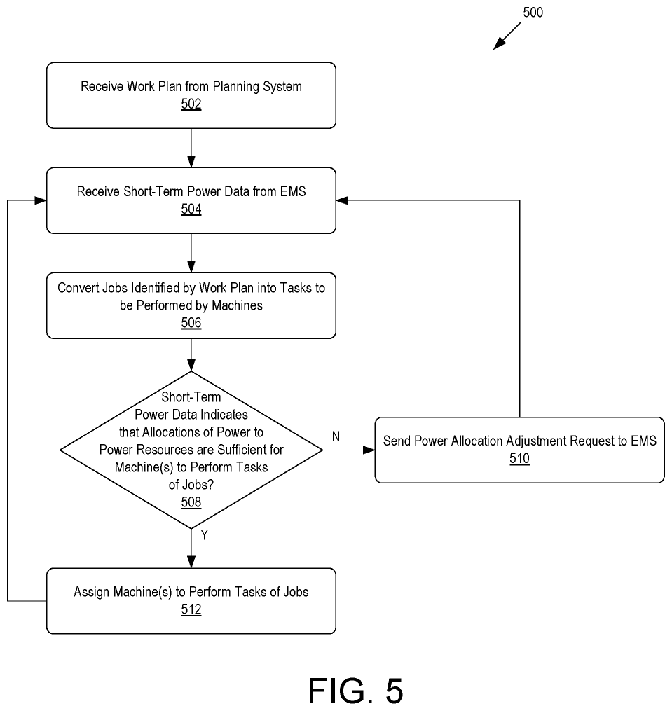

The EMS 110 may provide power allocation data 200 to the dispatch controller 112 and/or the planning system 114, for instance as long-term power data 118 and/or short-term power data 120. Operations of the EMS 110 are described further below with respect to FIG. 3. Operations of the planning system 114 based at least in part on the short-term power data 120 are described further below with respect to FIG. 4. Operations of the dispatch controller 112 based at least in part on the long-term power data 118 are described further below with respect to FIG. 5.

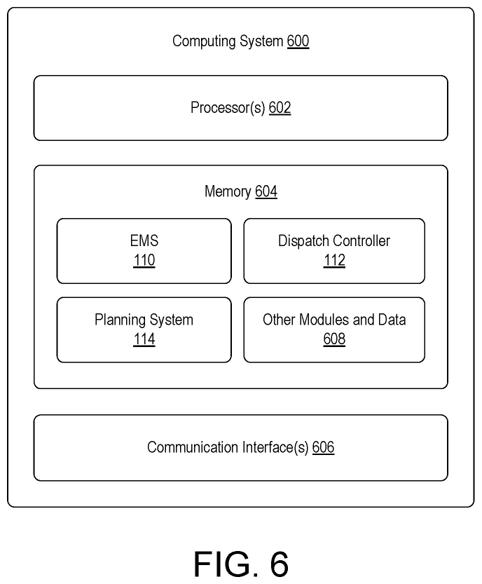

FIG. 3 is a flowchart 300 illustrating an exemplary process for providing long-term power data 118 to the planning system 114 and for providing short-term power data 120 to the dispatch controller 112. The operations shown in FIG. 3 may be performed by one or more computing systems, such as a computing system that executes the EMS 110. FIG. 6, discussed further below, describes an example system architecture for such a computing system.

At block 302, the computing system may generate long-term power data 118 associated with power resources 106 over a first period of time. The first period of time may be a relatively long future period of time, such as the next day, the next few days, or the next week. The power resources 106 may include elements of energy infrastructure associated with the worksite 104, such as charging stations, battery swap stations, substations, generators, renewal power sources, other power sources, and/or other elements. The long-term power data 118 generated at block 302 may indicate power levels associated with the power resources 106 over the first period of time. For example, the long-term power data 118 may indicate maximum power levels that could be allocated to the power resources 106 based on physical limitations of the power resources 106. In some examples, the long-term power data 118 may be provided or formatted as a tree or other hierarchical structure, for example as shown in FIG. 2.

As another example, the long-term power data 118 may also, or alternately, indicate expected or predicted allocations of power levels to the power resources 106 at one or more times over the first period of time. For instance, the EMS 110 may use weather forecasts, amounts of expected daylight at different times of day, and/or other data to predict that solar panels, wind turbines, or other renewal power sources may provide more or less power at different times throughout the first period of time. For instance, weather forecasts may indicate that solar panels are likely to provide less power during times in which cloudy conditions are expected, and/or that wind turbines are likely to provide less power during times in which calm weather without much wind is expected. In these examples, batteries or other energy storage components may provide other power resources 106 with power for a least a short period of time when weather conditions may prevent solar panels, wind turbines, or other renewal power sources from providing power.

The EMS 110 may accordingly indicate such variable power levels, expected to be allocated to power resources 106 throughout the first period of time, in the long-term power data 118. For instance, the long-term power data 118 may indicate that relatively high levels of power are expected to be allocated to power resources 106 during a first portion of a day, but that due to forecasted weather conditions that are likely to decrease available power and/or expected consumption of stored energy resources, lower levels of power are expected to be allocated to those power resources 106 during a later second portion of the day. Similarly, the EMS 110 may use planned maintenance schedules or other data to determine when particular power resources 106 are scheduled to be offline. The EMS 110 may accordingly indicate, in the long-term power data 118, how power levels allocated to the power resources 106 are expected to change throughout the first period of time due to planned maintenance and/or times at which particular power resources 106 are expected to be offline.

At block 304, the computing system may provide the long-term power data 118 to the planning system 114. In some examples, the EMS 110 and the planning system 114 may be executed by the same computing system, such that the computing system may use internal notifications or data sharing processes to provide the long-term power data 118 generated by the EMS 110 to the planning system 114. However, in other examples, the EMS 110 and the planning system 114 may be executed by different computing systems. In some of these examples, the computing system that executes the EMS 110 may send the long-term power data 118 to the planning system 114 via a network. In other examples, the computing system that executes the EMS 110 may publish the long-term power data 118 or otherwise make the long-term power data 118 available for retrieval by the planning system 114 over a network. For instance, the EMS 110 may send a notification to the planning system 114 over the network to inform the planning system 114 that new or updated long-term power data 118 is available for retrieval, such that the planning system 114 may retrieve the new or updated long-term power data 118 from the EMS 110.

At block 306, the computing system may generate short-term power data 120 associated with power resources 106 over a second period of time. The second period of time may include the current time, such that the short-term power data 120 may be real-time and/or near real-time data. The second period of time may also, or alternately, include a future time period that is shorter than the first period of time. For instance, while the first period of time may be a relatively long period of time such as the next day, the next few days, or the next week, the second period of time may be the next fifteen minutes, the next half hour, or the next hour.

The short-term power data 120 generated at block 306 may indicate power levels associated with the power resources 106 over the second period of time. In some examples, the short-term power data 120 may be provided or formatted as a tree or other hierarchical structure, for example as shown in FIG. 2. The short-term power data 120 may indicate power levels that are currently allocated to charging stations and/or other power resources 106. The short-term power data 120 may also, or alternately, indicate future power levels that the EMS 110 expects will be allocated to the power resources 106 over the second period of time.

As an example, the EMS 110 may plan to turn on an additional generator in five minutes, such that activation of the additional generator is expected to cause an increased amount of power to be available that may be allocated to one or more power resources 106. Accordingly, the short-term power data 120 may indicate power levels that are currently allocated to power resources 106, as well as higher power levels that are expected to be available and/or allocated to power resources 106 after the generator is activated.

As another example, the EMS 110 may plan to redistribute power or otherwise adjust how available power is allocated among one or more power resources 106, for instance in response to a power allocation adjustment request 128 from the dispatch controller 112 and/or other factors. Accordingly, the short-term power data 120 may indicate power levels that are currently allocated to power resources 106, and/or or adjusted power levels that are expected to be available and/or allocated to power resources 106 at one or more future times based on adjustments to power allocations made by the EMS 110 in response to a power allocation adjustment request 128 and/or other factors.

As another example, the EMS 110 may use weather forecasts to determine that a storm is expected to arrive at the worksite 104 in fifteen minutes, and that clouds from the storm are expected to decrease the amount of power provided by solar panels. Accordingly, the short-term power data 120 may indicate power levels that are currently allocated to power resources 106, as well as lower power levels that are expected to be available and/or allocated to power resources 106 due to the imminent storm. As discussed above, the worksite 104 may have batteries or other energy storage components that may help compensate for decreased power output from solar panels, wind turbines, or other renewable energy sources due to weather conditions or other factors. However, if the EMS 110 determines that a storm or other forecasted weather conditions are likely to impact power levels that will be allocated to power resources 106 in the relatively near future, for instance if current amounts of energy stored in batteries or other energy storage components at the worksite 104 are relatively low, the EMS 110 may indicate such near-term changes to expected power allocations in the short-term power data 120.

At block 308, the computing system may provide the short-term power data 120 to the dispatch controller 112. In some examples, the EMS 110 and the dispatch controller 112 may be executed by the same computing system, such that the computing system may use internal notifications or data sharing processes to provide the short-term power data 120 generated by the EMS 110 to the dispatch controller 112. However, in other examples, the EMS 110 and the dispatch controller 112 may be executed by different computing systems. In some of these examples, the computing system that executes the EMS 110 may send the short-term power data 120 to the dispatch controller 112 via a network. In other examples, the computing system that executes the EMS 110 may publish the short-term power data 120 or otherwise make the short-term power data 120 available for retrieval by the dispatch controller 112 over a network. For example, the EMS 110 may send a notification to the dispatch controller 112 over the network to inform the dispatch controller 112 that new or updated short-term power data 120 is available for retrieval, such that the 112/may retrieve the new or updated short-term power data 120 from the EMS 110.

At block 310, the computing system may determine whether a power allocation adjustment request 128 has been received from the dispatch controller 112. The dispatch controller 112 may send a power allocation adjustment request 128, for instance via a network or other communication link, to request that the EMS 110 adjust allocations of power to one or more power resources 106. For example, if the dispatch controller 112 is evaluating whether to assign a machine 102 to perform operations near a particular charging station, but the short-term power data 120 provided at block 308 indicates that current and/or future power levels allocated to that particular charging station may be too low to power those operations of the machine 102, the dispatch controller 112 may submit a power allocation adjustment request 128 to request an increase in the power allocated to the particular charging station.

If a power allocation adjustment request 128 has not been received (Block 310-No), the computing system may return to block 306 to generate new or updated short-term power data 120 for a subsequent second period of time. For example, if the second period of time associated with the short-term power data 120 is fifteen minutes, the computing system may generate and send new short-term power data 120 every fifteen minutes at block 306. Successive instances of short-term power data 120 may cover different successive fifteen-minute periods in this example, and may accordingly reflect any new or expected changes to power allocations over the different successive fifteen-minute periods. The dispatch controller 112 may receive new short-term power data 120 every fifteen minutes in this example, and may be able to dispatch machines 102 at the worksite 104 based in part on frequently-updated short-term power data 120 from the EMS 110.

If a power allocation adjustment request 128 has been received from the dispatch controller 112 (Block 310—Yes), the computing system may adjust allocations of power to one or more power resources 106 in response to the power allocation adjustment request 128 at block 312. For example, if the power allocation adjustment request 128 is a request that power allocated to a particular charging station be increased by a particular amount, the EMS 110 may attempt to satisfy that request by turning on one or more generators or accessing additional power from one or more power sources so that more power is available to be allocated to the particular charging station. The EMS 110 may also, or alternately, decrease power allocated to one or more other charging stations, so that more power is available to be allocated to the particular charging station. In some examples, the EMS 110 may be able to partially satisfy the power allocation adjustment request 128, for instance by increasing a power level allocated to a power resource 106 by less than a requested increase amount. In other examples, the EMS 110 may be unable to satisfy the power allocation adjustment request 128, such as if there is no extra power available and/or no way to reallocate available power without negatively impacting other operations at the worksite 104.

The computing system may also return to block 306 to generate new or updated short-term power data 120 that reflects any adjustments, if any, made at block 312 to allocations of power to power resources 106 in response to the power allocation adjustment request 128. For example, if the EMS 110 was able to fully satisfy or partially satisfy the power allocation adjustment request 128 by implementing a requested increase to an amount of power allocated to a particular power resource 106 or by increasing the amount of power allocated to the particular power resource 106 by less than a requested increase amount, the new or updated short-term power data 120 returned to the dispatch controller 112 may indicate the increased power level allocated to the particular power resource 106. If the EMS 110 was unable to adjust allocations of power in response to the power allocation adjustment request 128, the new or updated short-term power data 120 may indicate that the power levels allocated to power resources 106 has not changed.

The computing system may repeat one or more operations shown in FIG. 3 at different times. For example, the computing system may loop through block 306 through 312 to provide new or updated short-term power data 120 to the dispatch controller 112 on a relatively frequent basis associated with the second period of time, such as every fifteen minutes, every half hour, or every hour, and/or when the EMS 110 adjusts allocations of power in response to power allocation adjustment requests 128. The computing system may also repeat blocks 302 and 304, or restart the operations shown in FIG. 3, at other intervals associated with the longer first period of time. For example, if the first period of time is a day, the computing system may generate and send new long-term power data 118 to the planning system 114 once per day, and also generate and send new short-term power data 120 to the dispatch controller 112 multiple times per day.

As shown in FIG. 3, the computing system that executes the EMS 110 may provide long-term power data 118 to the planning system 114 and may provide short-term power data 120 to the dispatch controller 112. The planning system 114 may use the long-term power data 118 to generate a work plan 122, as discussed further below with respect to FIG. 4. The dispatch controller 112 may use the short-term power data 120 to dispatch machines 102 to perform operations at the worksite 104 based on the work plan 122 and the short-term power data 120, as discussed further below with respect to FIG. 5.

FIG. 4 is a flowchart 400 illustrating an exemplary process for generating a work plan 122 and providing the work plan 122 to the dispatch controller 112. The operations shown in FIG. 4 may be performed by one or more computing systems, such as a computing system that executes the planning system 114. FIG. 6, discussed further below, describes an example system architecture for such a computing system.

At block 402, the computing system that executes the planning system 114 may receive long-term power data 118 from the EMS 110. The long-term power data 118 may indicate power levels associated with corresponding power resources 106 over a future period of time, such as the next day, the next few days, or the next week. The long-term power data 118 may indicate maximum power levels that may be allocated to the power resources 106, and/or expected or predicted allocations of power levels to the power resources 106 at one or more times. In some examples, the long-term power data 118 may be provided or formatted as a tree or other hierarchical structure, for example as shown in FIG. 2. The computing system may receive long-term power data 118 sent by the EMS 110, for instance via a network or other communication link, or may retrieve long-term power data 118 that is published by the EMS 110 or is otherwise available to be retrieved from the EMS 110.

At block 404, the computing system may receive a definition of a set of jobs 124 to be performed at the worksite 104 over a day, a shift, or other period of time. In some examples, the definition of the set of jobs 124 may be provided by a user of the planning system 114, for instance via a user interface of the planning system 114. In other examples, the definition of a set of jobs 124 may be data uploaded or transferred to the planning system 114 from another data source. The definition of the set of jobs 124 received at block 404 may indicate particular jobs to be performed at the worksite 104 at one or more times. The jobs 124 may defined as goals for operations at the worksite 104, such as goals to excavate one or more types of material at one or locations at the worksite 104, goals to transport material to and/or from locations at the worksite 104, or goals to perform other types of operations at the worksite 104. As described herein, the jobs 124 may be defined via the planning system 114 as relatively broad goals, and the dispatch controller 112 may later convert the jobs 124 into specific tasks to be performed by machines 102 in order to achieve the goals of the jobs 124.

In some examples, the planning system 114 may display the long-term power data 118 received at block 402 to a user, such that the user may take the long-term power data 118 into account when defining jobs 124 at block 404. As an example, the long-term power data 118 may indicate that a relatively low maximum amount of power may be available at a first area of the worksite 104, while a higher maximum amount of power may be available at a second area of the worksite 104. Accordingly, the user may provide input that indicates that jobs associated with higher power usage, such as movement of larger amounts of material, should be performed at the first area and that jobs associated with lower power usage should be performed at the second area. As another example, if the long-term power data 118 indicates that a particular charging station is expected to be offline during a two-hour period during a shift, the user may avoid defining jobs that are to be performed during that two-hour period that are likely to involve machines 102 connecting to that particular charging station.

At block 406, the planning system 114 may generate estimated power usage levels 126 associated with execution of the jobs 124 defined at block 404. For example, based a defined job 124, the planning system 114 may predict or estimate that performance and/or completion of the job is likely to involve usage a certain amount of power, and/or predict or estimate amounts of power that should be allocated to charging stations or other power resources 106 to allow one or more machines 102 to perform the job 124. As described herein, the dispatch controller 112 may determine which machines 102 are to be assigned to that job 124 and/or which specific tasks or operations those machines 102 are to perform during performance of the overall job 124. However, the planning system 114 may predict or estimate an overall amount of power that may be associated with execution of the job 124 by one or more machines 102 to be selected later by the dispatch controller 112, and/or overall amounts of power that should be allocated to one or more power resources 106 to enable execution of the job 124 by machines 102 selected later by the dispatch controller 112.

At block 408, the computing system may determine whether the estimated power usage levels 126 determined at block 406 can be validated against the long-term power data 118 received at block 402. For instance, if the estimated power usage levels 126 indicate that a particular amount of power should be allocated to a charging station at the worksite 104 in order for a defined job 124 to be performed, the planning system 114 may determine whether the long-term power data 118 indicates that at least the particular amount of power will be, or can be, allocated to that charging station during a period of time associated with the job. As an example, the planning system 114 may attempt to verify that a maximum amount of power that can be allocated to the charging station, as indicated by the long-term power data 118, exceeds an estimated power usage level 126 associated with the job 124. As another example, the planning system 114 may attempt to verify that an amount of power that the long-term power data 118 indicates is expected to be allocated to the charging station during a period of time associated with the job 124 exceeds the estimated power usage level 126 associated with the job 124.

If the computing system determines that the estimated power usage levels 126 associated with defined jobs 124 are not validated against the long-term power data 118 (Block 408-No), the computing system may generate and/or display a power usage level warning at block 410. For example, if a user of the planning system 114 has defined one or more jobs 124 to be performed at the worksite 104, but the long-term power data 118 indicates that power sufficient to satisfy corresponding estimated power usage levels 126 is unlikely to be available at the worksite 104, the planning system 114 may prevent a corresponding warning to the user. The user may accordingly adjust the definitions of the jobs 124 at block 404 until corresponding estimated power usage levels 126 can be validated against the long-term power data 118 at block 408.

At block 412, the computing system may generate a work plan 122 that indicates the jobs 124 defined at block 404. For example, the work plan 122 may indicate types of the jobs 124, goals of the jobs 124, locations associated with the jobs 124, timeframes for performance of the jobs 124, and/or other information about the jobs 124. In some examples, the work plan 122 may also indicate the estimated power usage levels 126 associated with the jobs 124 and/or corresponding power resources 106. The work plan 122 may be associated with a particular period of time, such as a particular shift during a workday, an entire workday, or any other period of time.

At block 414, the computing system may provide the work plan 122 generated at block 412 to the dispatch controller 112. In some examples, the planning system 114 and the dispatch controller 112 may be executed by the same computing system, such that the computing system may use internal notifications or data sharing processes to provide the work plan 122 generated by the planning system 114 to the dispatch controller 112. However, in other examples, the planning system 114 and the dispatch controller 112 may be executed by different computing systems. In some of these examples, the computing system that executes the planning system 114 may send the work plan 122 to the dispatch controller 112 via a network. In other examples, the computing system that executes the planning system 114 may publish the work plan 122 or otherwise make the work plan 122 available for retrieval by the dispatch controller 112 over a network, and/or may send a notification to the dispatch controller 112 over the network to inform the dispatch controller 112 that the work plan 122 is available for retrieval.

In some examples, the computing system may skip some of the operations shown in FIG. 4. For instance, in some examples the planning system 114 may not be configured to generate estimated power usage levels 126. The computing system accordingly may skip block 406, block 408, and block 410 in these examples, and may omit the estimated power usage levels 126 from the work plan 122 generated at block 412.

As discussed above herein, the work plan 122 generated by the planning system 114 via the operations shown in FIG. 4 may indicate a set of jobs 124 to be performed at the worksite 104. The dispatch controller 112 may convert the jobs 124 indicated by the work plan 122 into specific tasks to be performed by machines 102, and may dispatch the machines 102 to perform the tasks based at least in part on short-term power data 120 provided by the EMS 110, as discussed below with respect to FIG. 5.

FIG. 5 is a flowchart 500 illustrating an exemplary process for dispatching machines 102 to perform operations at the worksite 104, based on a work plan 122 generated by the planning system 114 and based on short-term power data 120 generated by the EMS 110. The operations shown in FIG. 5 may be performed by one or more computing systems, such as a computing system that executes the dispatch controller 112. FIG. 6, discussed further below, describes an example system architecture for such a computing system.

At block 502, the computing system that executes the dispatch controller 112 may receive a work plan 122 generated by the planning system 114. The planning system 114 may have generated the work plan 122 via the operations discussed above with respect to FIG. 4. The work plan 122 may identify a set of jobs 124 to be performed at the worksite 104 during a shift, a day, or other period of time. For example, the work plan 122 may indicate types of the jobs 124, goals of the jobs 124, locations associated with the jobs 124, timeframes for performance of the jobs 124, and/or other information about the jobs 124. In some examples, the work plan 122 may also indicate the estimated power usage levels 126 associated with the jobs 124 and/or corresponding power resources 106.

In some examples, the planning system 114 may send the work plan 122 to the dispatch controller 112, for instance via a network or other communication link.

In other examples, the planning system 114 may publish the work plan 122 or otherwise make the work plan 122 available for retrieval by the dispatch controller 112, and may send a notification to the dispatch controller 112 indicating that the work plan 122 is available to be accessed.

At block 504, the computing system that executes the dispatch controller 112 may receive short-term power data 120 from the EMS 110. The EMS 110 may have generated the short-term power data 120 via the operations discussed above with respect to FIG. 3. The short-term power data 120 may indicate power levels associated with corresponding power resources 106 at a current time and/or over a relatively short future period of time. For example, the short-term power data 120 may indicate power levels that are currently allocated to power resources 106, and/or power levels that are expected or predicted to be allocated to power resources 106 over the next fifteen minutes, the next half hour, or the next hour.

In some examples, the short-term power data 120 may be provided or formatted as a tree or other hierarchical structure, for example as shown in FIG. 2. The computing system may receive short-term power data 120 sent by the EMS 110, for instance via a network or other communication link, or may retrieve short-term power data 120 that is published by the EMS 110 or is otherwise available to be retrieved from the EMS 110.

At block 506, the computing system may convert the jobs 124 identified by the work plan 122 into corresponding tasks and/or operations that may be performed by one or more machines 102. For example, if a job 124 included in a work plan 122 for a particular shift indicates that a particular amount of material is to be moved between two locations at the worksite during a shift or during a particular period of time within a shift, the computing system may determine how many machines 102 may be used to transport that amount of material between the two locations, determine routes for the machines to travel while loaded and/or unloaded between the two locations, determine types and/or times of particular operations to load and unload material, and/or determine other tasks or operations that may be associated with performance of the overall job.

The dispatch controller 112 may also determine that the machines 102 should at least occasionally connect to power resources 106 at one or more times and/or locations during performance of the job, for instance to charge batteries 108 and/or to otherwise power operations of the machines 102 during performance of the job. The dispatch controller 112 may accordingly select machines 102 to be associated with jobs 124, determine the number of machines 102 to be associated with jobs 124, and/or determine particular tasks to be performed by selected machines 102 based at least in part on current and/or future allocations of power to power resources 106 indicated by the short-term power data 120.

At block 508, the computing system may determine whether the short-term power data 120 received at block 504 indicates that current and/or future allocations of power to power resources 106 are sufficient for one or more machines 102 to perform tasks associated with corresponding jobs 124. As an example, the computing system may estimate or predict that, for a set of BEMs to perform a job during a shift, the BEMs may need to periodically connect to particular charging stations and may use a particular amount of power provided by those charging stations. The computing system may accordingly determine whether the short-term power data 120 indicates that power allocated to the particular charging stations will be sufficient to provide to the BEMs. As another example, the computing system may use estimated power usage levels 126, associated with jobs 124 and/or power resources 106, indicated by the work plan 122 received at block 502 to determine whether the short-term power data 120 indicates that power allocated to the particular charging stations will meet or exceed the estimated power usage levels 126.

If the short-term power data 120 indicates that allocations of power to the power resources 106 may not be sufficient to allow one or more machines 102 to perform tasks associated with one or more jobs 124 (Block 508-No), the computing system may send a power allocation adjustment request 128 to the EMS 110 at block 510. The power allocation adjustment request 128 may request that the EMS 110 adjust power allocations to one or more power resources 106 such that the power allocations are adjusted to be sufficient to allow one or more machines 102 to perform tasks associated with one or more jobs 124. The EMS 110 may attempt to satisfy the power allocation adjustment request 128 by reallocating power among various power resources 106 and/or be accessing additional available power that may be allocated to power resources 106, for instance by turning on additional generators or accessing additional power from external sources.

As described above with respect to FIG. 3, the EMS 110 may return new or updated short-term power data 120 to the dispatch controller 112 indicating whether the EMS 110 was able to fully or partially satisfy the power allocation adjustment request 128 and/or how the EMS 110 adjusted allocations of power to the power resources 106 in response to the power allocation adjustment request 128. The computing system may accordingly receive new or updated short-term power data 120 at block 504 after sending the power allocation adjustment request 128 at block 510. The computing system may also re-convert one or more jobs 124 indicated by the work plan 122 into corresponding, or adjust previously-determined tasks corresponding to such jobs 124, based on the new or updated short-term power data 120. For instance, if updated short-term power data 120 indicates that power levels allocated to a particular charging station have increased relative to previous short-term power data 120, the dispatch controller 112 may determine that more machines 102 may be assigned to connect to that particular charging station, or that individual machines 102 may connect to that particular charging station for longer periods of time.

If the short-term power data 120 indicates that allocations of power to the power resources 106 are likely to be sufficient to allow machines 102 to perform tasks associated with jobs 124 (Block 508—Yes), at block 512 the computing system associated with the dispatch controller 112 may assign those machines 102 to perform the tasks associated with the jobs 124. For example, the computing system may transmit assignment and/or dispatch instructions to wireless communication elements of the machines 102. The machines 102 may have screens or other displays that may present the instructions from the dispatch controller 112 to operators of the machines 102, such that the operators may cause the machines 102 to perform indicated tasks. The machines 102 may also, or alternately, have ECMs 116 or other on-board computing systems that may cause the machines 102 to perform indicated tasks autonomously or semi-autonomously based on the instructions from the dispatch controller 112.

FIG. 6 is a schematic illustration depicting an exemplary architecture of a computing system 600 that executes one or more elements described in the present disclosure. The computing system 600 may include one or more processors 602, memory 604, and communication interfaces 606. The computing system 600 may include one or more computers, servers, or other types of computing devices. Individual computing devices of the computing system 600 may have the system architecture shown in FIG. 6, or a similar system architecture.

The computing system 600 may execute one or more elements of the worksite system 100 described herein, such as the EMS 110, the dispatch controller 112, and/or the planning system 114. In some of these examples, the computing system 600 may include one or more local servers and/or other local computing devices that are physically present at or near the worksite 104. In other examples, the computing system 600 may include one or more remote servers or other remote computing systems that are located at a remote location relative to the worksite 104. For instance, the computing system 600 may be executed via one or more remote servers, a cloud computing environment, or other computing systems or elements that are not present at the worksite 104.

In some examples, elements associated with the worksite system 100 may be distributed among, and/or be executed by, multiple computing systems or devices similar to the computing system 600 shown in FIG. 6. As an example, the planning system 114 may be executed by a different computing system than a computing system that executes the EMS 110 and/or the dispatch controller 112. As another example, individual elements of the worksite system 100, such as the EMS 110, the dispatch controller 112, and/or the planning system 114, may be executed by the same computing system or may be distributed among different computing systems. The computing system 600 may, in some examples, include or be part of a cloud computing environment or other distributed system that hosts and/or executes one or more elements associated with the worksite system 100.

The processor(s) 602 of the computing system 600 may operate to perform a variety of functions as set forth herein. The processor(s) 602 may include one or more chips, microprocessors, application specific integrated circuits (ASICs), field programmable gate arrays (FPGAs) and/or other programmable circuits, central processing units (CPUs), graphics processing units (GPUs), digital signal processors (DSPs), and/or other processing units or components known in the art. In some examples, the processor(s) 602 may have one or more arithmetic logic units (ALUs) that perform arithmetic and logical operations, and/or one or more control units (CUs) that extract instructions and stored content from processor cache memory, and executes such instructions by calling on the ALUs during program execution. The processor(s) 602 may also access content and computer-executable instructions stored in the memory 604, and execute such computer-executable instructions.

The memory 604 may be volatile and/or non-volatile computer-readable media including integrated or removable memory devices including random-access memory (RAM), read-only memory (ROM), flash memory, a hard drive or other disk drives, a memory card, optical storage, magnetic storage, and/or any other computer-readable media. The computer-readable media may be non-transitory computer-readable media. The computer-readable media may be configured to store computer-executable instructions that may be executed by the processor(s) 602 to perform the operations described herein.

For example, the memory 604 may include a drive unit and/or other elements that include machine-readable media. A machine-readable medium may store one or more sets of instructions, such as software or firmware, that embodies any one or more of the methodologies or functions described herein. The instructions may also reside, completely or at least partially, within the processor(s) 602 and/or communication interface(s) 606 during execution thereof by the computing system 600. For example, the processor(s) 602 may possess local memory, which also may store program modules, program data, and/or one or more operating systems.

The memory 604 may store data and/or computer-executable instructions associated with elements of the worksite system 100 described herein. For example, the memory 604 may store data and/or computer-executable instructions associated with the EMS 110, the dispatch controller 112, and/or the planning system 114.

The memory 604 may also store other modules and data 608 that may be utilized by the computing system 600 to perform or enable performing any action taken by the computing system 600. For example, the other modules and data 608 may include a platform, operating system, and/or applications, as well as data utilized by the platform, operating system, and/or applications.

The communication interfaces 606 may include transceivers, modems, interfaces, antennas, and/or other components that may transmit and/or receive data over networks or other data connections. In some examples, the communication interfaces 606 may be wireless communication interfaces and/or wired communication interfaces that the computing system 600 may use to send and/or receive data. As an example, if the computing system 600 executes the EMS 110, the EMS 110 may use the communication interfaces 606 to send long-term power data 118 to the planning system 114, to send short-term power data 120 to the dispatch controller 112, to receive power allocation adjustment requests 128 from the dispatch controller 112, and/or to exchange data with power resources 106. As another example, if the computing system 600 executes the dispatch controller 112, the dispatch controller 112 may use the communication interfaces 606 to receive work plans 122 from the planning system 114, to receive short-term power data 120 from the EMS 110, to send power allocation adjustment requests 128 to the EMS 110, and/or to exchange data with elements of machines 102. As yet another example, if the computing system 600 executes the planning system 114, the planning system 114 may use the communication interfaces 606 to receive long-term power data 118 from the EMS 110 and to send work plans 122 to the dispatch controller 112.

### INDUSTRIAL APPLICABILITY

As described herein, the EMS 110 may manage allocations of power to charging stations and other power resources 106 at the worksite 104. The EMS 110 provide the planning system 114 with long-term power data 118 indicating maximum and/or expected power allocations to the power resources 106 over a relatively long period of time, such as the next day or the next week. The planning system 114 may determine a work plan 122 for jobs 124 to be performed at the worksite 104 during a shift, a day, or other period of time, based on maximum or expected allocations of power to the power resources 106 during that period of time as indicated by the long-term power data 118. The EMS 110 may also provide the dispatch controller 112 with short-term power data 120 indicating current and/or expected power allocations over a shorter period of time, such the next fifteen minutes, the next half hour, or the next hour. The dispatch controller 112 may assign machines 102 to perform tasks associated with the jobs 124 identified by the work plan 122 generated by the planning system 114, based on current and/or future allocations of power indicated by the short-term power data 120.

Accordingly, the long-term power data 118 and the short-term power data 120 provided by the EMS 110 may allow other components of the worksite system 100 to operate based at least in part on data indicating current, future, and/or possible allocations of power to corresponding power resources 106 at the worksite 104. Operations of such components, and/or operations of machines 102 at the worksite 104, may be more efficient due to consideration of such power allocation data.

For example, many types of machines that have historically operated at worksites were not BEMs, and were instead powered by diesel or other types of fuel. Such fuel-powered machines may be able to operate at a worksite for relatively long periods of time, such as 12 to 24 hours, between stops to refuel at fueling stations. Accordingly, because such machines may be able to operate for entire shifts or even entire days before the machines are refueled, many conventional planning systems and/or dispatch systems are not configured to consider allocations of power to electrical charging stations and/or other types of power resources at a worksite when planning jobs to be performed at the worksite and/or when dispatching machines to perform tasks associated with such jobs at the worksite.

However, many BEMs may only be able to operate for shorter periods of time, such as 1 to 2 hours, between times at which the BEMs connect to charging stations. Some operations performed by BEMs may also be optimally performed while the BEMs are connected to trolley systems or other power resources. For instance, a BEM that is tasked to drive downhill into a mine pit, be loaded with material, and then drive uphill out of the mine pit while loaded may not have a sufficient battery charge to power all of those operations, but may connect to a trolley system while traveling uphill to power the uphill travel operations.

Accordingly, conventional systems that do not take allocations of power to electrical charging stations and/or other types of power resources at a worksite may lead to machines being stranded without power at locations at the worksite, and/or lead to machines waiting for charging stations with allocated power to become available. Such scenarios may negatively impact the amount of productive work that may be performed by the machines at the worksite.

As an example, some conventional planning systems may be used to plan jobs to be performed at a worksite. However, such conventional planning may not have access to any data indicating how much power is expected to be allocated to charging stations or other power resources at the worksite. Accordingly, a user of such a conventional planning system may inadvertently design jobs to be performed during a shift that would require a set of machines to use more power than may actually be allocated to charging stations or other power resources at the worksite during the shift.

This may lead to one or more machines becoming stranded and/or waiting for available power, during which time the machines may not be performing productive work.

As another example, some conventional dispatch systems may dispatch machines to perform tasks at a worksite without consideration of current and/or future allocations of power to charging stations or other power resources at the worksite. For instance, although a conventional dispatch system may dispatch a fuel-powered machine to perform tasks for six or more hours between refueling stops, such a conventional dispatch system may not be configured to consider that a BEM may only be able to operate for two hours between recharging stops, and/or may not be configured to assign such BEMs to connect to charging stations at locations and/or times based on how much power is allocated to those charging stations. These issues may also lead to one or more machines becoming stranded and/or waiting for available power, during which time the machines may not be performing productive work.

However, because the planning system 114 may generate a work plan 122 based on long-term power data 118 indicating maximum and/or expected power allocations to power resources 106 over a period of time, the planning system 114 may determine the jobs 124 of the work plan 122 based at least in part on such power allocations to power resources 106 at the worksite 104. For instance, the planning system 114 may determine the work plan 122 such that indicted jobs 124 are likely to be able to be performed based on maximum and/or expected power allocations to power resources 106. This may improve productivity at the worksite 104, relative to work plans created without consideration of how much power will be allocated to power resources 106 and how such allocations may impact the likelihood that jobs of the work plans may be able to be performed and/or completed based on such allocations of power.

Similarly, because the work plan 122 may be generated by the planning system 114 based at least in part on allocations of power to power resources 106 indicated by the long-term power data 118, the dispatch controller 112 may be more likely to be able to assign machines 102 to perform tasks of the jobs 124 indicted by the work plan based on such allocations of power to power resources 106. The dispatch controller 112 may also be able to better determine which machines 102 to assign to perform tasks and/or how to assign machines 102 to perform tasks, based on current allocations of power and/or expected future allocations of power indicated by the short-term power data 120.

Overall, by configuring the planning system 114 to generate work plans 122 for shifts, days, or other relatively long periods of time based on allocations of power to power resources 106 indicated by long-term power data 118, and/or by configuring the dispatch controller 112 to assign machines to perform tasks associated with jobs 124 indicted by the work plans based on current and/or future allocations of power to the power resources 106 indicated by short-term power data 120, productivity and efficiency at the worksite 104 may be increased. As an example, machines 102 may be more likely be able to perform tasks of jobs 124 indicated by a work plan 122 for a shift generated by the planning system 114, because the planning system 114 generates the work plan 122 based at least in part on allocations of power to power resources 106 indicated by the long-term power data 118.

While aspects of the present disclosure have been particularly shown and described with reference to the embodiments above, it will be understood by those skilled in the art that various additional embodiments may be contemplated by the modification of the disclosed machines, systems, and method without departing from the spirit and scope of what is disclosed. Such embodiments should be understood to fall within the scope of the present disclosure as determined based upon the claims and any equivalents thereof.

What is claimed is:

1. A method comprising:
managing, by an energy management system (EMS) executed via a computing system, allocations of power to power resources associated with a worksite;
generating, by the EMS, long-term power data indicating the allocations of power over a first period of time;
generating, by the EMS, short-term power data indicating the allocations of power over a second period of time, the second period of time being shorter than the first period of time;
providing, by the EMS, the long-term power data to a planning system via a network;
receiving, by a dispatch controller executed via the computing system, a work plan associated with the worksite from the planning system via the network, wherein:
the work plan indicates at least one job to be performed at the worksite during the first period of time, and
the planning system generated the work plan based at least in part on the long-term power data; and
dispatching, by the dispatch controller, at least one machine at the worksite to perform operations associated with the at least one job indicated by the work plan, based at least in part on the allocations of power to the power resources over the second period of time indicated by the short-term power data.

2. The method of claim 1, further comprising:
generating, by the EMS, updated short-term power data at intervals corresponding to the second period of time; and
adjusting, by the dispatch controller, the operations to be performed by the at least one machine based on the updated short-term power data.

3. The method of claim 1, further comprising:
determining, by the dispatch controller, that the allocations of power to the power resources indicated by the short-term power data are likely to be insufficient to power the operations of the at least one machine associated with the at least one job;
providing, by the dispatch controller, a power allocation adjustment request to the EMS, wherein the power allocation adjustment request identifies a requested change to the allocations of power to cause the allocations of power to become sufficient to power the operations of the at least one machine;
performing, by the EMS, an adjustment to the allocations of power to the power resources, based on the power allocation adjustment request; and
generating, by the EMS, updated short-term power data based on the adjustment to the allocations of power,
wherein the dispatch controller dispatches the at least one machine to perform the operations based at least in part on the updated short-term power data.

4. The method of claim 1, wherein the work plan identifies estimated power usage levels associated with execution of the at least one job.

5. The method of claim 1, wherein the power resources include at least one charging station or other energy infrastructure element configured to at least one of:
charge at least one battery of the at least one machine, or
power the operations of the at least one machine at the worksite.

6. The method of claim 1, wherein:
at least one of the long-term power data or the short-term power data is represented as a tree comprising nodes representing individual power resources, and
the tree identifies particular allocations of power to corresponding nodes.

7. The method of claim 1, wherein the long-term power data, provided by the EMS to the planning system, identifies at least one of:
maximum power levels that are possible to allocate to the power resources during the first period of time, or
expected power levels that the EMS predicts will be allocated to the power resources at one or more times during the first period of time.

8. The method of claim 7, wherein the EMS predicts the expected power levels based at least one of weather forecasts, times of day, maintenance plans, or energy availability schedules.

9. The method of claim 1, wherein the short-term power data identifies at least one of:
power levels the EMS has currently allocated to the power resources, or
expected power levels that the EMS predicts will be allocated to the power resources at one or more times during the second period of time.

10. A worksite system, associated with a worksite, comprising:
an energy management system (EMS) configured to:
manage allocations of power to power resources at the worksite;
provide a planning system with long-term power data indicating allocations of power to the power resources over a first period of time; and
output short-term power data indicating the allocations of power to the power resources over a second period of time that is shorter than the first period of time; and
a dispatch controller configured to:
receive the short-term power data from the EMS;
receive a work plan, indicating at least one job to be performed at the worksite during the first period of time, from the planning system, the planning system having generated the work plan based at least in part on the long-term power data; and
dispatch at least one machine at the worksite to perform operations, associated with the at least one job indicated by the work plan, based at least in part on the allocations of power to the power resources over the second period of time indicated by the short-term power data.

11. The worksite system of claim 10, wherein:
the dispatch controller is configured to submit a power allocation adjustment request to the EMS based on a determination that the allocations of power to the power resources indicated by an initial instance of the short-term power data are likely to be insufficient to power the operations associated with the at least one job,
the EMS is configured to adjust the allocations of power based on the power allocation adjustment request and to provide updated short-term power data to the dispatch controller, and
the dispatch controller is configured to dispatch the at least one machine to perform the operations based at least in part on the updated short-term power data.

12. The worksite system of claim 10, wherein the work plan identifies estimated power usage levels associated with execution of the at least one job.

13. The worksite system of claim 10, wherein:
at least one of the long-term power data or the short-term power data is represented as a tree comprising nodes representing individual power resources, and
the tree identifies particular allocations of power to corresponding nodes.

14. The worksite system of claim 10, wherein the long-term power data, provided by the EMS to the planning system, identifies at least one of:
maximum power levels that are possible to allocate to the power resources during the first period of time, or
expected power levels that the EMS predicts will be allocated to the power resources at one or more times during the first period of time.

15. The worksite system of claim 10, wherein the short-term power data identifies at least one of:
power levels the EMS has currently allocated to the power resources, or
expected power levels that the EMS predicts will be allocated to the power resources at one or more times during the second period of time.

16. A computing system comprising:
a processor; and
a memory having stored thereon computer-executable instructions that, when executed by the processor, cause the processor to:
manage allocations of power to power resources associated with a worksite;
generate a work plan, indicating at least one job to be performed at the worksite during a first period of time, based on long-term power data indicating the allocations of power to the power resources over the first period of time; and
dispatch at least one machine at the worksite to perform operations, associated with the at least one job indicated by the work plan, based on least in part on short-term power data indicating the allocations of power to the power resources over a second period of time that is shorter than the first period of time.

17. The computing system of claim 16, wherein the computer-executable instructions cause the processor to:
determine that the allocations of power to the power resources indicated by the short-term power data are likely to be insufficient to power the operations of the at least one machine associated with the at least one job;
generate a power allocation adjustment request identifying a requested change to the allocations of power to cause the allocations of power to become sufficient to power the operations of the at least one machine;
adjust the allocations of power to the power resources, based on the power allocation adjustment request; and
dispatch the at least one machine to perform the operations based at least in part on updated short-term power data indicating adjustments made to the allocations of power based on the power allocation adjustment request.

18. The computing system of claim 16, wherein the work plan identifies estimated power usage levels associated with execution of the at least one job.

19. The computing system of claim 16, wherein:
at least one of the long-term power data or the short-term power data is represented as a tree comprising nodes representing individual power resources, and
the tree identifies particular allocations of power to corresponding nodes.

20. The computing system of claim 16, wherein:
the long-term power data identifies at least one of:
maximum power levels that are possible to allocate to the power resources during the first period of time, or
first expected power levels predicted to be allocated to the power resources at one or more first times during the first period of time, and
the short-term power data identifies at least one of:
power levels that are currently allocated to the power resources, or
second expected power levels predicted to be allocated to the power resources at one or more second times during the second period of time.
